(19) United States
(12) Patent Application Publication
(10) Pub. No.: US 2008/0266392 A1
(43) Pub. Date: Oct. 30, 2008

(54) INFRA-RED CLOSED CIRCUIT TELEVISION CAMERA ADJUSTING DISTANCE AND FOCUS BY ONE ELEMENT

(76) Inventor: Min Soo Park, Kyungki-do (KR)

Correspondence Address: MARC E. HANKIN, ESQ., 11414 THURSTON CIRCLE, LOS ANGELES, CA, 90049, US

(21) Appl. No.: 11/868,943

(22) Filed: Oct. 8, 2007

(30) Foreign Application Priority Data
Apr. 30, 2007 (KR) 10-2007-7105

(51) Int. Cl. H04N 7/18; H04N 5/33

(52) U.S. Cl. 348/143; 348/164; 348/E07.085; 348/E05.09

(57) ABSTRACT

The invention relates to a distance adjusting and focus adjusting Infra Red Closed Circuit Television (IR CCTV) surveillance camera offering distance adjusting and focus adjusting in a single unit, enabling a smaller sized camera while lowering production costs. A focus adjusting shaft, configured to drive a focus adjuster that adjusts focus by enlarging or reducing the lens aperture, is configured as a single unit with a distance adjusting shaft, configured to drive a distance adjuster that adjusts distance to the subject, by rotational adjustments.

### FIELD OF INVENTION

This invention relates, generally, to Infra-Red Closed Circuit Television (IR CCTV) surveillance cameras; more particularly to IR CCTV surveillance cameras equipped with focus adjusting and distance adjusting.

This application claims priority to the Korean Application for Patent Number 10-2007-7105 filed on Apr. 30, 2007, for Infra-Red Closed Circuit Television Adjusting Distance and Focus by One Element, the contents of which are incorporated herein by reference in their entirety.

### BACKGROUND

Generally, CCTV (Closed Circuit Television) surveillance cameras are installed along walls or ceilings of public buildings, financial institutions, or residential areas, viewing and recording situations for the purpose of monitoring the passers by.

Infra-Red Closed Circuit Television (IR CCTV) surveillance cameras enable recording when there is no visible light, during nighttime or in dark places or other difficult to monitor situations. The IR CCTV surveillance camera is equipped with IR LEDs around its lens sections to emit IR light, making it possible to capture images at nighttime.

An IR CCTV surveillance camera using existing technology is documented in the Korean registered utility model number 0382143, and thus a detailed description of such structure is omitted here. However, the IR CCTV surveillance camera using known technology has the following problems.

The known IR CCTV surveillance camera includes a case with exterior controls. The case includes an exterior focus adjusting shaft, for the purpose of rotating the focus adjusting gear for focus adjusting. Furthermore, the case includes an exterior distance adjusting shaft for the purpose of rotating the distance adjusting gear for distance adjusting. Because the exterior focus adjusting shaft and exterior distance adjusting shaft are separately configured and separately installed, substantial work time is required to install and operate them, and the camera's volume is increased due to the large space required inside the case to accommodate the focus adjusting shaft and the distance adjusting shaft.

### SUMMARY OF THE INVENTION

Embodiments of the invention relate to Infra Red Closed Circuit Television (IR CCTV) surveillance cameras equipped with distance adjusting and focus adjusting mechanisms provided in a single unit, enabling cameras having sizes smaller in volume, appropriate for lowering production costs. The single unit provides for driving the focus adjuster that adjusts focus by enlarging or reducing the lens aperture, and includes a distance adjusting shaft for driving the distance adjuster that adjusts distances to a subject by rotation.

According to embodiments of this invention, the IR CCTV camera includes a case, a lens mount that is installed inside the case that includes a lens, a distance adjuster that is installed in the lens mount and that adjusts the distance to a subject by moving the lens frontward and rearward via rotation, and a focus adjuster that adjusts focus by enlarging or reducing a lens aperture via rotation and that is installed in the lens mount symmetrical to the distance adjuster. The IR CCTV surveillance camera further includes a separately installed LED plate equipped with IR LEDs configured forward of the lens mount to interact with a distance adjusting gear that is fixed and connected on an outer rim of the distance adjuster. The distance adjusting gear is configured to include teeth arranged in a radial shape extending in a perpendicular direction from the distance adjusting gear. A focus adjusting gear is fixed and connected on the outer rim of the focus adjuster. The focus adjusting gear is configured to include teeth arranged in a radial shape extending in a perpendicular direction from the focus adjusting gear. A focus adjusting prime gear meshes with the focus adjusting gear, the focus adjusting prime gear mounted on a focus adjusting shaft having a tubular form that is installed through a seal created in the case's rear. A distance adjusting shaft is inserted and installed inside the focus adjusting shaft to expose the front and rear of the distance adjusting shaft to the outside, to accommodate a distance adjusting prime gear, which meshes with the distance adjusting gear, the distance adjusting prime gear fixed on the front side of the distance adjusting shaft. According to this configuration, the embodiments provide a benefit of lowered production costs and reduced volume size of the camera.

Other features and advantages of this invention will become apparent from the following description of several embodiments of the invention, taken in conjunction with the accompanying drawings, which illustrate, by way of example, the principles of the invention.

### BRIEF DESCRIPTION OF THE DRAWINGS

FIG. 1 is an exploded perspective view of an embodiment of an IR CCTV surveillance camera illustrating the distance and focus adjusting single unit according to the present invention.

FIG. 2 is an assembled cross-section lateral view of the embodiment illustrated in FIG. 1.

FIG. 3 is a perspective view of a portion of the embodiment illustrated in FIG. 2.

FIG. 4 is a cross-section lateral view of a portion of the embodiment illustrated in FIG. 2.

FIG. 5 is a lateral view of an operational example of the distance and focus adjusting single unit illustrated in FIG. 2.

### DRAWINGS

### Reference Numerals

102: Case
102a: Rear side
102a′: Seal
110: Lens mount
112: Distance adjuster
114: Focus adjuster
122: Distance adjusting gear
122a: Gear measurement
124: Focus adjusting gear
132: Distance adjusting prime gear
134: Focus adjusting prime gear
142: Distance adjusting shaft
142a: O-ring groove
144: Focus adjusting shaft
150: LED plate
150a: Insertion hole
151: IR LEDs
160: O-ring
172: Distance adjusting knob
174: Focus adjusting knob

### DETAILED DESCRIPTION OF THE DRAWINGS

In the following detailed description of various embodiments of the invention, numerous specific details are set forth in order to provide a thorough understanding of various aspects of one or more embodiments of the invention, however, one or more embodiments of the invention may be practiced without these specific details. In other instances, well-known methods, procedures, and/or components have not been described in detail so as not to unnecessarily obscure aspects of embodiments of the invention.

In the following description, certain terminology is used to describe certain features of one or more embodiments of the invention. For instance, “surveillance camera” or “camera” refers to any type of “optical device,” and “IR LEDs” refers to any device that is used to produce light, including lamps, individual LEDs, and arrays of multiple LEDs.

To achieve the above purposes, among others, a distance adjusting and focusing adjusting single unit IR CCTV camera is provided. The camera includes a case, a lens mount that is installed inside the case that includes a lens, a distance adjuster that is installed in the lens mount and that adjusts the distance to a subject by moving the lens frontward and rearward via rotation, and a focus adjuster that adjusts focus by enlarging or reducing a lens aperture via rotation and that is installed in the lens mount symmetrical to the distance adjuster. The IR CCTV surveillance camera further includes a separately installed LED plate equipped with IR LEDs configured forward of the lens mount to interact with a distance adjusting gear that is fixed and connected on an outer rim of the distance adjuster. The distance adjusting gear is configured to include teeth arranged in a radial shape extending in a perpendicular direction from the distance adjusting gear. A focus adjusting gear is fixed and connected on the outer rim of the focus adjuster. The focus adjusting gear is configured to include teeth arranged in a radial shape extending in a perpendicular direction from the focus adjusting gear. A focus adjusting prime gear meshes with the focus adjusting gear, the focus adjusting prime gear mounted on a focus adjusting shaft having a tubular form that is installed through a seal created in the case's rear. A distance adjusting shaft is inserted and installed inside the focus adjusting shaft to expose the front and rear of the distance adjusting shaft to the outside, to accommodate a distance adjusting prime gear, that meshes with the distance adjusting gear, the distance adjusting prime gear fixed on the front side of the distance adjusting shaft.

The distance adjusting and focus adjusting single unit, of the IR CCTV surveillance camera proposed here, includes the distance adjusting shaft and the focus adjusting shaft. To prevent the distance adjusting shaft from free floating within the distance adjusting shaft, the unit features O-rings which also provides waterproofing of the space between the distance adjusting shaft and the focus adjusting shaft.

The O-rings of the distance adjusting and focus adjusting single unit are inserted into radial positions on the distance adjusting shaft, one the interior of the focus adjusting shaft. The distance adjusting shaft is configured for the purpose of inserting and fixing the above O-rings into position.

The following describes in detail an operational example of an embodiment of the distance adjusting and focus adjusting single unit of an IR CCTV surveillance camera, by reference to the attached drawings.

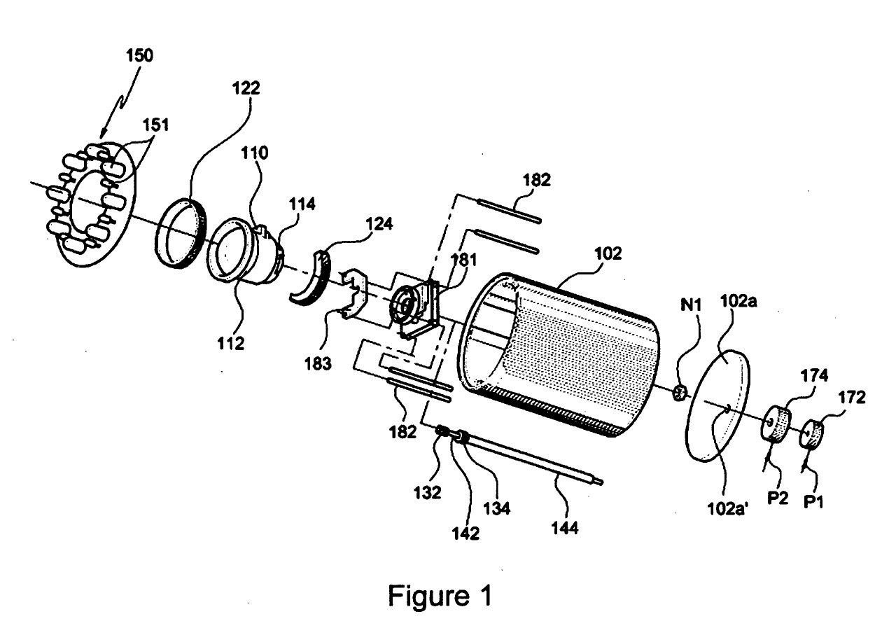

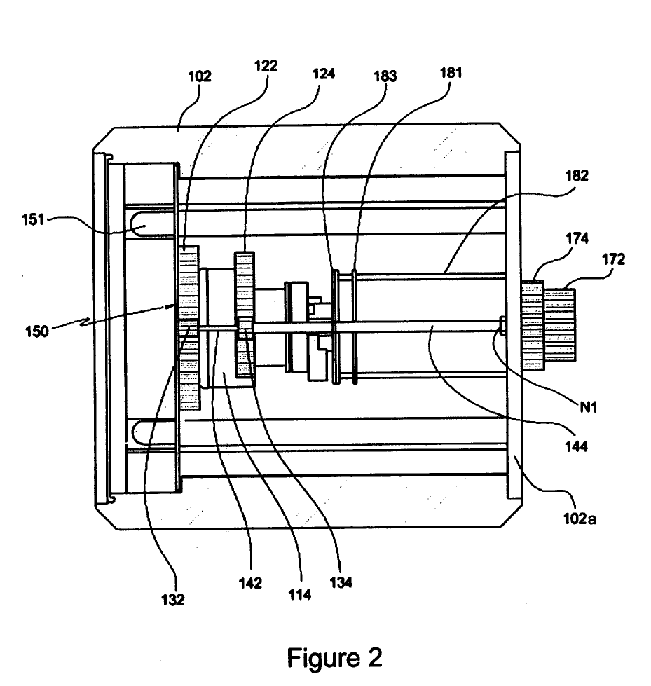

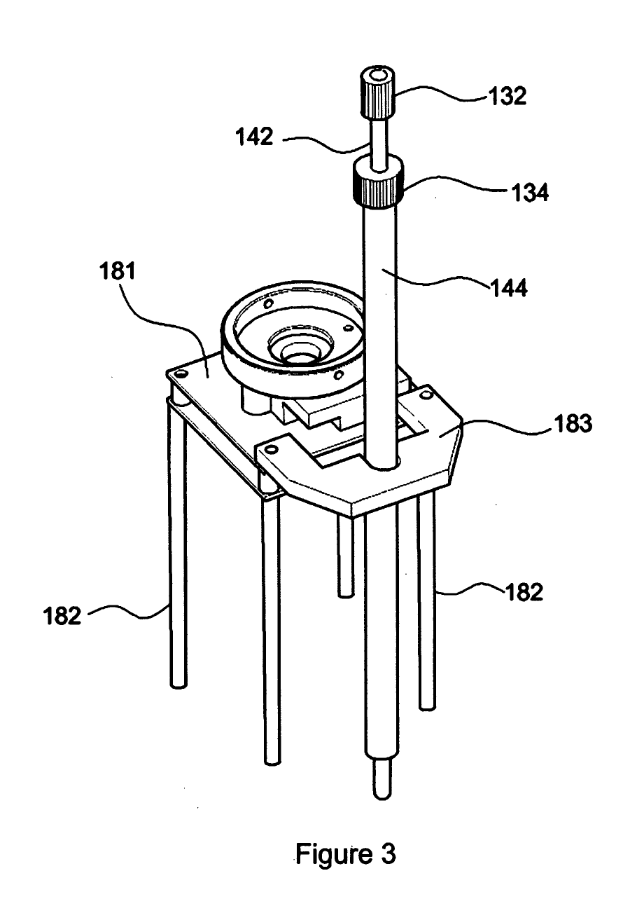

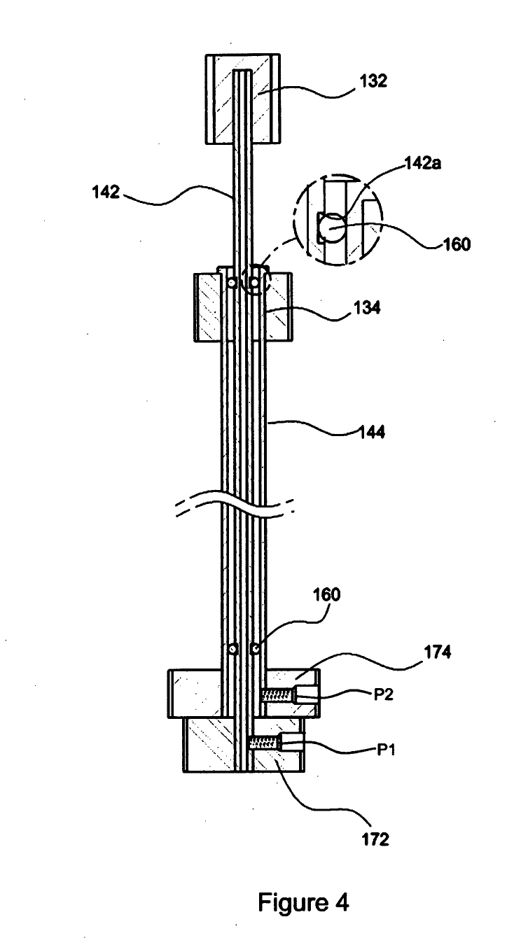

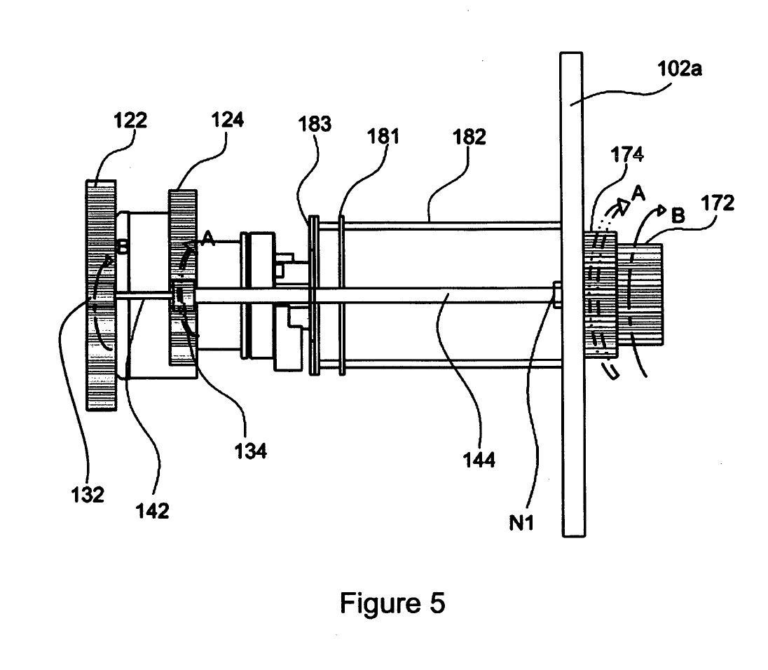

FIG. 1 illustrates an exploded perspective view of the distance adjusting and focus adjusting single unit IR CCTV surveillance camera's major part's in detail. FIG. 2 is an assembled cross-section lateral view of the embodiment illustrated in FIG. 1. FIG. 3 is a perspective view of a portion of the embodiment illustrated in FIG. 2. FIG. 4 is a cross-section lateral view of a portion of the embodiment illustrated in FIG. 2. FIG. 5 is a lateral view of an operational example of the distance and focus adjusting single unit illustrated in FIG. 2.

As illustrated in FIGS. 1-5, the distance adjusting and focus adjusting single unit IR CCTV surveillance camera includes a case 102, a lens mount 110 that is installed inside the case 102 and that includes a lens, a distance adjuster 112 that is installed in the lens mount 110 and that adjusts the distance to subjects by moving the lens forward and rearward by rotation, a focus adjuster 114 that adjusts the focus by enlarging or reducing the lens aperture by rotation and that is installed in the lens mount 110 symmetrically to the distance adjuster 112. The IR CCTV surveillance camera includes a separately installed LED plate 150 equipped with IR LEDs 151 and installed forward of the lens mount 110. The camera further includes a distance adjusting gear 122, a focus adjusting gear 124, a focus adjusting prime gear 134, a focus adjusting shaft 144, a distance adjusting shaft 142, and a distance adjusting prime gear 132.

The distance adjusting gear 122 is connected and fixed on the exterior rim of the distance adjuster 112, and the gear teeth are formed in a radial configuration perpendicular to the forward direction.

The focus adjusting gear 124 is connected and fixed down on the exterior rim of the focus adjuster 114, and the gear teeth are formed in a radial configuration perpendicular to the forward direction.

The focus adjusting prime gear 134 meshes with the focus adjusting gear 124.

The focus adjusting shaft 144 can be embodied by a tube form, whose shaft connects to the focus adjusting prime gear 134, and passes through the installed seal 102a′ positioned in the rear 102a of the case 102.

The distance adjusting shaft 142 is inserted and installed on the interior of the focus adjusting shaft 144, to expose the front and rear portions of the distance adjusting shaft 142 outside the focus adjusting shaft 144.

The distance adjusting prime gear 132 is connected on the front side of the distance adjusting shaft 142 and fixed to the distance adjusting shaft 142, so that the distance adjusting prime gear 132 meshes with the distance adjusting gear 122.

In an operational example of an embodiment as illustrated in FIG. 4, the distance adjusting shaft 142 and the focus adjusting shaft 144 are interposed. To prevent the distance adjusting shaft 142 from floating freely, the distance adjusting shaft 142 and focus adjusting shaft 144 are configured by including O-rings 160 that provide a waterproof function for the space between the distance adjusting shaft 142 and the focus adjusting shaft 144. The O-ring groove 142a, formed by a radial groove on the exterior of the distance adjusting shaft 142, provides for insertion of and fixes the O-ring 160.

Preferably, an O-ring 160 is installed on the front side of the focus adjusting shaft 144. A pair of O-rings 160 can be installed on the distance adjusting shaft 142 along with an O-ring 160.

The O-ring 160 performs a waterproofing function, while at the same time, performs the function of preventing the distance adjusting shaft 142 from floating freely.

On the rear side of the distance adjusting shaft 142, the distance adjusting knob 172 is connected, and on the rear side of the focus adjusting shaft 144, the focus adjusting knob 174 is connected. The diameter of the focus adjusting knob 174 extends to the outside of the diameter of the distance adjusting knob 172.

The focus adjusting knob 174 is fixed on the focus adjusting shaft 144 using the screw P2, and the distance adjusting knob 172 is fixed on the distance adjusting shaft 142 using the screw P1.

By configuring the distance adjusting knob 172 to be arranged at the axial interior of the focus adjusting knob 174 as described above, the product volume can be further reduced, and at the same time, convenience of operation is increased.

The seal 102a′ (see FIG. 1) is used to install the distance adjusting shaft 142 and the focus adjusting shaft 144 (i.e., two shafts installed into the case), and the installation can be formed using only one seal for two shafts, so work time is reduced, and as a result, overall cost of production is reduced.

Reference numeral 181 illustrated in FIGS. 1-3 is a PCB board that is installed with an imaging device (for example, a CCD element). Reference numeral 182 is an installation shaft configured to install the PCB board at the rear of the case. Reference numeral 183 is a fixing bracket to fix down the focus adjusting shaft 144 securely on the PCB board 181 to prevent free floating. Reference numeral N1 is the nut to fix down the focus adjusting shaft 144 on the case without free floating.

The following describes functional aspects of the distance adjusting and focus adjusting single unit IR CCTV surveillance camera proposed here.

As illustrated in FIG. 5, when focus is adjusted, if the focus adjusting knob 174 is turned (turning in direction A as illustrated in FIG. 5), the focus adjusting shaft 144, the focus adjusting prime gear 134, and the focus adjusting gear 124 rotate, so focus is adjusted by rotating the focus adjuster 114 (see, e.g., FIGS. 1 and 2).

Similarly, when adjusting the distance (in other words, when zooming in/zooming out), if the distance adjusting knob 172 is turned in direction B as illustrated in FIG. 5, the distance adjusting shaft 142, the distance adjusting prime gear 132, and the distance adjusting gear 122 rotate, so distance/zoom is adjusted by rotating the distance adjuster 112 (see, e.g., FIG. 1).

As set forth above, the distance adjusting function and the focus adjusting function are independently operable.

The actual operational example of the device set forth above is only an operational example of the design's technological concept. To a general technician in this industry, modified operational examples are within the scope of this device's technology.

### BENEFITS OF THE INVENTION

Embodiments of the distance adjusting and focus adjusting single unit IR CCTV surveillance camera with the configuration and functions as described above have the following benefits.

First, by configuring as a single unit the distance adjusting shaft 142, that drives the distance adjuster 112 which adjusts the distance to subjects, inside the focus adjusting shaft 144 that drives the focus adjuster 114, the benefit is achieved of reducing the product's volume and production costs at the same time.

Second, by configuring the distance adjusting knob 172 coaxially with a smaller diameter than the focus adjusting knob 174 as described above, it has the benefit of reducing the product's volume more and at the same time, convenience of operation is increased.

Third, unlike known technology, the seal 102a′, which is used to install two shafts, the distance adjusting shaft 142 and the focus adjusting shaft 144, into the case, only one seal is used, so production time is reduced, and as a result, the benefit is achieved of reducing the overall costs of production.

While multiple embodiments are disclosed, still other embodiments of the present invention will become apparent to those skilled in the art from the foregoing detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention shall not be interpreted to limit the scope of the invention. Various embodiments of the invention remain useable in tandem or combination of one another.

What is claimed is:

1. A single unit distance and focus adjusting Infra-Red Closed Circuit Television surveillance camera, comprising:
a case;
a lens mount installed inside the case that mounts a lens;
a distance adjuster installed in the lens mount and configured to adjust the distance to a subject by moving the lens frontward toward the subject and rearward away from the subject, via rotation;
a focus adjuster that adjusts focus by enlarging or reducing the lens aperture by rotation, installed in the lens mount opposite the distance adjuster;
a separately installed LED plate installed forward of the lens mount and equipped with Infra-Red LEDs;
a distance adjusting gear connected and fixed to an exterior rim of the distance adjuster, including gear teeth formed in a perpendicular radial configuration;
a focus adjusting gear connected and fixed to an exterior rim of the focus adjuster, including gear teeth formed in a perpendicular radial configuration;
a focus adjusting prime gear that meshes with the focus adjusting gear;
a focus adjusting shaft, having a tubular structure, connecting to the focus adjusting prime gear and passing through a rear side of the case via a seal;
a distance adjusting shaft installed in an interior of the focus adjusting shaft to thereby expose the front and rear ends of the distance adjusting shaft; and
a distance adjusting prime gear mounted to the distance adjusting shaft that meshes with the distance adjusting gear; wherein
distance adjusting and focus adjusting are provided by the distance adjusting shaft and focus adjusting shaft.

2. The camera of claim 1, further comprising:
one or more O-rings configured and arranged to provide coaxial spacing between the distance adjusting shaft and focus adjusting shaft, thereby preventing the distance adjusting shaft from free floating and functioning as a waterproof seal for the space coaxially between the distance adjusting shaft and the focus adjusting shaft.

3. The camera of claim 2, wherein:
the distance adjusting shaft includes one or more O-ring grooves created by one or more radial grooves on an exterior of the distance adjusting shaft, thereby providing for insertion of and fixing in place the one or more O-rings.
